(19) United States
(12) Patent Application Publication
(10) Pub. No.: US 2022/0131411 A1
(43) Pub. Date: Apr. 28, 2022

(54) MOVING OBJECT, SERVER, AND COMPUTER READABLE RECORDING MEDIUM

(71) Applicant: TOYOTA JIDOSHA KABUSHIKI KAISHA, Aichi-ken (JP)

(72) Inventors: Shogo TSUGE, Fuji-shi (JP); Kengo HACHIYA, Susono-shi (JP); Kyoko ITOH, Susono-shi (JP); Hitoshi HIBINO, Susono-shi (JP); Hiroya CHIBA, Susono-shi (JP)

(21) Appl. No.: 17/510,385

(22) Filed: Oct. 26, 2021

(30) Foreign Application Priority Data
Oct. 28, 2020 (JP) 2020-180716

(51) Int. Cl. H02J 50/10; G07C 5/00; G05B 15/02; G06K 9/00

(52) U.S. Cl. CPC H02J 50/10; G07C 5/008; G06K 9/00335; G06K 9/00832; G05B 15/02

(57) ABSTRACT

A moving object includes: a contact power receiver connected to an external contact power feeding device and configured to receive power from the external contact power feeding device; a non-contact power receiver configured to receive power from an external non-contact power feeding device in a non-contact manner; a detector configured to detect a state of an occupant boarding the moving object; and determination circuitry configured to determine which of the contact power receiver and the non-contact power receiver is utilized to receive the power based on the state of the occupant.

The present application claims priority to and incorporates by reference the entire contents of Japanese Patent Application No. 2020-180716 filed in Japan on Oct. 28, 2020.

### BACKGROUND

The present disclosure relates to a moving object, a server, and a computer readable recording medium.

There has been known a vehicle including a connection charger and a non-contact charger. The connection charger is connected to a power source device to receive power. The non-contact charger receives power from the power source device in a non-contact manner.

### SUMMARY

There is a need for a moving object, a server, and a computer readable recording medium for appropriately selecting a power receiving method in a vehicle capable of using a plurality of power receiving methods.

According to one aspect of the present disclosure, there is provided a moving object including: a contact power receiver connected to an external contact power feeding device and configured to receive power from the external contact power feeding device; a non-contact power receiver configured to receive power from an external non-contact power feeding device in a non-contact manner; a detector configured to detect a state of an occupant boarding the moving object; and determination circuitry configured to determine which of the contact power receiver and the non-contact power receiver is utilized to receive the power based on the state of the occupant.

According to another aspect of the present disclosure, there is provided a server including a processor configured to receive information on a state of an occupant boarding a moving object from the moving object, and determine which of a contact power receiver and a non-contact power receiver is utilized to receive power based on the received information, the a contact power receiver being connected to an external contact power feeding device and configured to receive the power from the external contact power feeding device, and the non-contact power receiver being configured to receive the power from an external non-contact power feeding device in a non-contact manner.

### BRIEF DESCRIPTION OF THE DRAWINGS

FIG. 1 schematically illustrates the configuration of a charging system including a moving object according to an embodiment;

FIG. 2 is a block diagram illustrating details of the moving object according to the embodiment;

FIG. 3 is a block diagram illustrating details of a server; and

FIG. 4 is a flowchart illustrating processing of the moving object according to the embodiment.

### DETAILED DESCRIPTION

A moving object, a server, and a computer readable recording medium storing a determination program according to an embodiment of the present disclosure will be described with reference to the drawings. Note that components in the embodiment below include those that may be easily replaced by those skilled in the art, or those that are substantially the same.

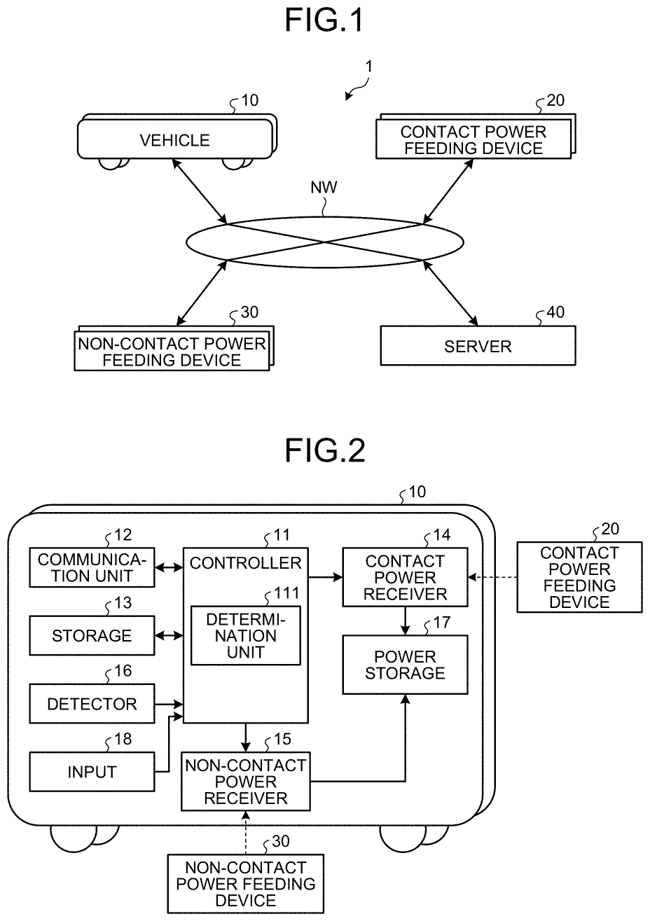

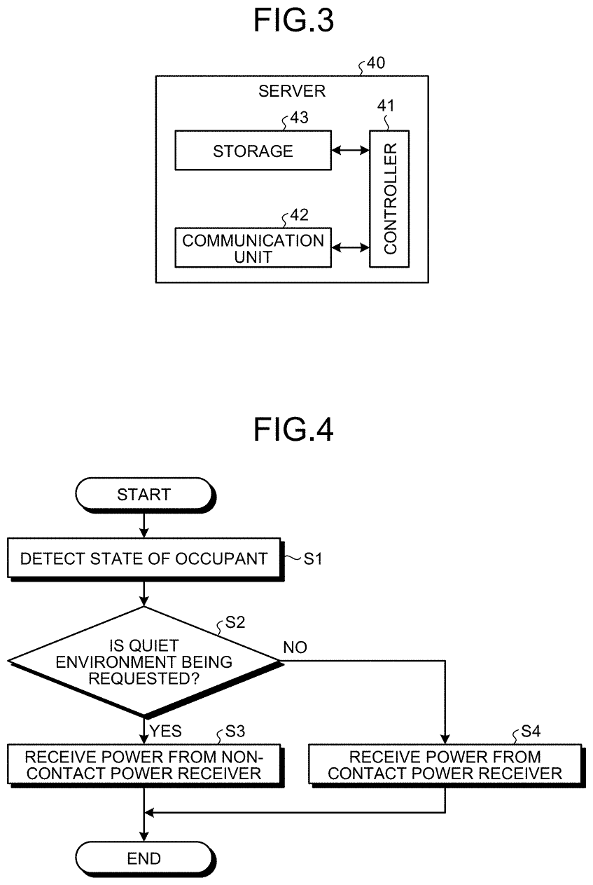

The configuration of a charging system including a moving object according to the embodiment will be described with reference to FIGS. 1 to 3. As illustrated in FIG. 1, a charging system 1 includes a vehicle 10 serving as a moving object, a contact power feeding device 20, a non-contact power feeding device 30, and a server 40.

The vehicle 10, the contact power feeding device 20, the non-contact power feeding device 30, and the server 40 may communicate with each other over a network NW. The network NW is, for example, a public communication network such as the Internet, and may include a wide area network (WAN), a telephone communication network for mobile phones and the like, and other communication networks such as a wireless communication network and the like including WiFi (registered trademark) and the like.

The vehicle 10 is a vehicle that is made to travel by driving of a driver or an autonomous traveling vehicle that may autonomously travel depending on a given travel command. As illustrated in FIG. 2, the vehicle 10 includes a controller 11, a communication unit 12, a storage 13, a contact power receiver 14, a non-contact power receiver 15, a detector 16, a power storage 17, and an input 18. Furthermore, although, in the following description, the vehicle 10 will be described as an example of the moving object, the moving object is not limited thereto, and may be a bus, a taxi, a drone, an airplane, a ship, and the like.

Specifically, the controller 11 includes a processor and a memory (main storage). The processor includes a central processing unit (CPU), a digital signal processor (DSP), a field-programmable gate array (FPGA), and the like. The memory (main storage) includes a random access memory (RAM), a read only memory (ROM), and the like.

The controller 11 loads a program stored in the storage 13 into a work area of the main storage, and executes the program. The controller 11 implements a function that matches a predetermined purpose by controlling each component and the like through execution of the program. Furthermore, the controller 11 includes a later-described determination unit 111.

The communication unit 12 includes, for example, a local area network (LAN) interface board and a wireless communication circuit for wireless communication. The communication unit 12 is connected to the network NW such as the Internet, which is a public communication network. Then, the communication unit 12 is connected to the network NW to communicate with the contact power feeding device 20, the non-contact power feeding device 30, and the server 40.

The storage 13 includes a recording medium such as an erasable programmable ROM (EPROM), a hard disk drive (HDD), and a removable medium. Examples of the removable medium include a recording medium such as an optical disk (e.g., compact disc (CD)-R or CD-ROM, digital versatile disc (DVD)—or DVD-ROM, and Blu-ray (registered trademark) disc (BD)) and a flash memory (e.g., universal serial bus (USB) memory and memory card). The storage 13 may store an operating system (OS), various programs, various tables, various databases, and the like.

The contact power receiver 14 is connected to the contact power feeding device 20 outside the vehicle 10 to receive power. Specifically, the contact power receiver 14 includes a charging inlet. The charging inlet has a shape in which a charging connector of the contact power feeding device 20 may be connected, and has a built-in terminal electrically connected to a terminal of the charging connector. When the charging connector is connected to the charging inlet, a terminal in the charging inlet and a terminal built in the charging connector come in contact with each other. As a result, the charging inlet receives power from the contact power feeding device 20. The power received in the charging inlet is stored in the power storage 17.

The non-contact power receiver 15 receives power from the non-contact power feeding device 30 outside the vehicle 10 in a non-contact manner. Specifically, the non-contact power receiver 15 includes a power receiving coil. The power receiving coil converts AC power received in a non-contact manner (i.e., without a contact between the non-contact power receiver 15 and the non-contact power feeding device 30) from a power transmitting coil of the contact power feeding device 20 into DC power, converts a voltage into a desired voltage, and then stores the power in the power storage 17.

The detector 16 detects the state of an occupant boarding a vehicle. The detector 16 includes a camera that images the occupant, and detects the state of the occupant by imaging the occupant. For example, the detector 16 detects the state of the occupant by analyzing the image captured by the camera and detecting the posture of the occupant in the image. Specifically, when an occupant holds a writing instrument and faces downward in the image captured by the camera, the detector 16 detects that the occupant is studying. Furthermore, when an occupant closes the eyelids in the image captured by the camera, the detector 16 detects that the occupant is sleeping. Furthermore, when detecting that an occupant is reading, talking, and working with a tablet terminal or a laptop computer in addition to studying and sleeping, the detector 16 may detect that the occupant is requesting a quiet environment. Furthermore, the detector 16 is required to be able to detect the state of an occupant, and may detect the state of the occupant with a motion sensor, voice input, line-of-sight recognition, a switch for the occupant to input the state of the occupant himself/herself, and the like. Furthermore, the detector 16 may include a wearable terminal worn by an occupant, and may detect the state of the occupant by detecting vital information such as body temperature, pulse, brain waves, blood pressure, a sweating state, and the like of the occupant.

The power storage 17 is a chargeable/dischargeable DC power source, and includes, for example, a secondary battery such as nickel metal hydride and lithium ions.

The input 18 includes an input device such as a touch panel superimposed on a display made of liquid crystal or organic electro luminescence (EL) of a car navigation, voice input through a microphone, a keyboard, and a switch. The input 18 receives input with a finger, voice, and the like of an occupant of the vehicle 10, and outputs a signal corresponding to the input to the controller 11. The input 18 receives input in a power receiving method desired by the occupant.

The determination unit 111 determines by which of the contact power receiver 14 and the non-contact power receiver 15 power is to be received based on the state of the occupant detected by the detector 16. When the detector 16 detects that the occupant is requesting a quiet environment, the determination unit 111 determines that power is to be received by the non-contact power receiver 15. When the detector 16 does not detect that the occupant is requesting a quiet environment, the determination unit 111 determines that power is to be received by the contact power receiver 14.

The server 40 comprehensively manages information on a plurality of contact power feeding devices including the contact power feeding device 20 and information on a plurality of non-contact power feeding devices including the non-contact power feeding device 30. The server 40 is provided in a management center that manages the contact power feeding device and the non-contact power feeding device, for example. The server 40 includes a controller 41, a communication unit 42, and a storage 43. The controller 41, the communication unit 42, and the storage 43 are physically similar to the controller 11, the communication unit 12, and the storage 13, respectively.

Next, a method of the vehicle 10 according to the embodiment configured as described above determining a power receiving method in accordance with the state of an occupant will be described. FIG. 4 is a flowchart illustrating processing of the moving object according to the embodiment. In the power receiving method determination processing described below, a power receiving method is automatically determined in accordance with the state of an occupant. The power receiving method determination processing is executed in the vehicle 10.

First, when detecting that the power storage 17 has a power storage amount equal to or less than a predetermined value, the controller 11 determines that power feeding is necessary, and executes processing of determining a power receiving method. Furthermore, the controller 11 may execute the processing of determining a power receiving method in accordance with input of an occupant of the vehicle 10 to the input 18.

When the power receiving method determination processing is executed, the detector 16 detects the state of an occupant boarding a vehicle (Step S1). The detector 16 detects the state of the occupant by imaging the occupant with a camera, and stores data of the captured image in the storage 13.

Subsequently, the detector 16 analyzes the image data, detects that the occupant is studying or sleeping, and detects that the occupant is requesting a quiet environment (Step S2). Note that, when a plurality of occupants boards the vehicle 10, the detector 16 may detect the state of only a preliminarily selected occupant among the plurality of occupants. For example, the detector 16 may detect the state of occupants other than a driver among a plurality of occupants. Furthermore, when the vehicle 10 is an autonomous traveling vehicle, the detector 16 may detect the states of all occupants.

Then, the determination unit 111 determines by which of the contact power receiver 14 and the non-contact power receiver 15 power is to be received based on the state of the occupant detected by the detector 16.

When the detector 16 detects that the occupant is requesting a quiet environment (Step S2: Yes), the determination unit 111 determines that the controller 11 causes power to be received from the non-contact power receiver 15 (Step S3). When the detector 16 detects that the occupant is studying or sleeping, the determination unit 111 guides the vehicle 10 to the non-contact power feeding device 30 by displaying a route to the non-contact power feeding device 30 on a display of a car navigation of the vehicle 10, a display of a smartphone of the occupant of the vehicle 10, or the like. Note that the controller 11 may confirm whether or not the occupant desires the non-contact power receiving method by displaying a confirmation screen for confirming whether or not the non-contact power receiving method is acceptable on the display. When the vehicle 10 arrives at the non-contact power feeding device 30, the controller 11 displays an instruction to receive power with the non-contact power receiver 15 on the display, and causes the non-contact power receiver 15 to receive power from the non-contact power feeding device 30. Furthermore, when the vehicle 10 is an autonomous traveling vehicle, the controller 11 may automatically move the vehicle 10 to the non-contact power feeding device 30. Note that, when a plurality of occupants boards the vehicle 10, the determination unit 111 causes power to be received from the non-contact power receiver 15 when the detector 16 detects that even one of the occupants is studying or sleeping.

When the detector 16 does not detect that the occupant is requesting a quiet environment (Step S2: No), the determination unit 111 determines that the controller 11 causes power to be received from the contact power receiver 14 (Step S4). When the detector 16 does not determine that the occupant is studying or sleeping, the determination unit 111 guides the vehicle 10 to the contact power feeding device 20 by displaying a route to the contact power feeding device 20 on a display of a car navigation of the vehicle 10, a display of a smartphone of the occupant of the vehicle 10, or the like. Note that the controller 11 may confirm whether or not the occupant desires the contact power receiving method by displaying a confirmation screen for confirming whether or not the contact power receiving method is acceptable on the display. When the vehicle 10 arrives at the contact power feeding device 20, the controller 11 displays an instruction to receive power with the contact power receiver 14 on the display, and causes the contact power receiver 14 to receive power from the contact power feeding device 20. Furthermore, when the vehicle 10 is an autonomous traveling vehicle, the controller 11 may automatically move the vehicle 10 to the contact power feeding device 20.

As described above, according to the moving object, the server, and the determination program according to the embodiment, the determination unit 111 determines a power receiving method in accordance with whether or not an occupant is requesting a quiet environment, so that the power receiving method may be appropriately selected in a vehicle in which a plurality of power receiving methods may be used.

When the occupant is requesting a quiet environment, power is received from the non-contact power receiver 15, so that it is possible to prevent the occupant from being disturbed while the occupant is studying or sleeping due to sound and vibration generated at the time when the charging inlet of the contact power receiver 14 is connected to the charging connector of the contact power feeding device 20.

In contrast, when the occupant is not requesting the quiet environment, power is received from the contact power receiver 14, so that the time required to store power in the power storage 17 may be shortened as compared with that in the case when the non-contact power receiver 15 is used.

Although, in the embodiment, an example in which the controller 11 of the vehicle 10 includes the determination unit 111 has been described, the controller 41 of the server 40 may have the function of the determination unit. In the case, the communication unit 42 acquires information on the state of an occupant boarding the vehicle 10 from the detector 16 of the vehicle 10 via the network NW, and stores the information in the storage 43. Then, the controller 41 determines by which of the contact power receiver 14 and the non-contact power receiver 15 power is to be received based on the information stored in the storage 43. When detecting that the occupant is studying or sleeping and the occupant is requesting a quiet environment based on the information stored in the storage 43, the controller 41 determines that power is to be received by the non-contact power receiver 15. Specifically, the information stored in the storage 43 is, for example, an occupant image obtained by the detector 16 imaging the occupant. When the occupant holds a writing instrument and faces downward in the image, the controller 41 detects that the occupant is studying. Furthermore, when the occupant closes the eyelids in the image, the controller 41 detects that the occupant is sleeping. Then, the controller 41 displays the determination result on a display of a car navigation of the vehicle 10, a display of a smartphone of the occupant of the vehicle 10, and the like. Power is thereby received by the determined power receiving method.

Additional effects and variations may be easily derived by those skilled in the art. The broader aspects of the present disclosure are not limited to the particular details and the representative embodiment illustrated and described above. Consequently, various modifications may be made without departing from the spirit or scope of the general concept of the disclosure defined by the appended claims and equivalents thereof.

For example, the determination unit 111 may determine that the occupant is not requesting a quiet environment. When the occupant wears earphones or a loudspeaker of the vehicle is reproducing voice, the determination unit 111 may determine that the occupant is not requesting a quiet environment, and determine that power is to be received by the contact power receiver 14 based on the information detected by the detector 16.

Furthermore, although, in the embodiment, an example in which the vehicle 10 moves toward the contact power feeding device 20 or the non-contact power feeding device 30 has been described, the movable contact power feeding device 20 or the movable non-contact power feeding device 30 may move toward the vehicle 10. In the case, the determination unit 111 determines which of the contact power feeding device 20 and the non-contact power feeding device 30 is to be moved toward the vehicle 10 in accordance with the state of the occupant. Then, the vehicle 10 transmits the determination result of the determination unit 111 to the server 40, and the controller 41 of the server 40 moves either of the contact power feeding device 20 or the non-contact power feeding device 30 toward the vehicle 10.

Furthermore, although, in the embodiment, an example in which a power receiving method is determined in accordance with the behavior of the occupant such as studying and sleeping has been described, the power receiving method may be determined in accordance with a schedule of the occupant. For example, when rapid charging is necessary due to a schedule of the occupant, the determination unit 111 may determine that power is to be received by the non-contact power receiver 15. Furthermore, the controller 11 may preliminarily schedule a method, place, and time for power feeding in accordance with the schedule of the occupant.

Furthermore, the determination unit 111 may determine by which of the contact power receiver 14 and the non-contact power receiver 15 power is to be received in accordance with input of the power receiving method desired by the occupant received by the input 18. Each time charging is performed, the controller 11 may display a selection screen for selecting by which of the contact power receiver 14 and the non-contact power receiver 15 power is to be received on the display of the car navigation of the vehicle 10, the display of the smartphone of the occupant of the vehicle 10, or the like, and causes the occupant to perform selection. The controller 11 may execute power receiving method determination processing without displaying the selection screen. Furthermore, the determination unit 111 may determine whether or not the occupant is requesting a quiet environment in accordance with input from a touch panel superimposed on the display, voice input, a switch, and the like.

Furthermore, when the occupant requests reduction of the charging time during the power reception performed by the non-contact power receiver 15, the power reception may be switched to power reception performed by the contact power receiver 14 in accordance with instruction input of the occupant.

Furthermore, the program to be executed by the vehicle 10 according to the embodiment may be provided while being recorded in a computer-readable recording medium such as a CD-ROM, a flexible disk (FD), a CD-R, a digital versatile disk (DVD), a USB medium, and a flash memory as file data in an installable format or an executable format.

Furthermore, the program to be executed by the vehicle 10 according to the embodiment may be provided by being stored in a computer connected to a network such as the Internet and downloaded via the network.

According to the present disclosure, a power receiving method may be appropriately selected in a vehicle capable of using a plurality of power receiving methods.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A moving object comprising:
a contact power receiver connected to an external contact power feeding device and configured to receive power from the external contact power feeding device;
a non-contact power receiver configured to receive power from an external non-contact power feeding device in a non-contact manner;
a detector configured to detect a state of an occupant boarding the moving object; and
determination circuitry configured to determine which of the contact power receiver and the non-contact power receiver is utilized to receive the power based on the state of the occupant.

2. The moving object according to claim 1, wherein the determination circuitry is configured to determine that the non-contact power receiver is utilized to receive the power in a case where the detector detects that the occupant is requesting a quiet environment.

3. The moving object according to claim 1, wherein the determination circuitry is configured to determine that the non-contact power receiver is utilized to receive the power in a case where the detector detects that the occupant is studying or sleeping.

4. The moving object according to claim 3, wherein
the detector includes a camera configured to capture an image of the occupant, and
the detector is configured to detect that the occupant is studying in a case where the occupant holds a writing instrument and faces downward in the image captured by the camera.

5. The moving object according to claim 3, wherein
the detector includes a camera configured to capture an image of the occupant, and
the detector is configured to detect that the occupant is sleeping in a case where eyelids of the occupant are closed in the image captured by the camera.

6. The moving object according to claim 1, wherein the determination circuitry is configured to determine that the contact power receiver is utilized to receive the power in a case where the detector detects that the occupant wears an earphone or a loudspeaker of the moving object reproduces sound.

7. The moving object according to claim 1, further comprising an input device configured to receive an input of a power receiving method desired by the occupant,
wherein the determination circuitry is configured to determine which of the contact power receiver and the non-contact power receiver is utilized to receive the power in accordance with the power receiving method input by the input device.

8. A server comprising
a processor configured to
receive information on a state of an occupant boarding a moving object from the moving object, and
determine which of a contact power receiver and a non-contact power receiver is utilized to receive power based on the received information, the a contact power receiver being connected to an external contact power feeding device and configured to receive the power from the external contact power feeding device, and the non-contact power receiver being configured to receive the power from an external non-contact power feeding device in a non-contact manner.

9. The server according to claim 8, wherein the processor is configured to determine that the non-contact power receiver is utilized to receive the power in a case where the processor detects that the occupant is requesting a quiet environment based on the received information.

10. The server according to claim 8, wherein the processor is configured to determine that the non-contact power receiver is utilized to receive the power in a case where the processor detects that that the occupant is studying or sleeping is detected based on the received information.

11. The server according to claim 10, wherein
the received information includes an image of the occupant, and
the processor is configured to detect that the occupant is studying in a case where the occupant holds a writing instrument and faces downward in the image.

12. The server according to claim 10, wherein the received information includes an image of the occupant, and
the processor is configured to detect that the occupant is sleeping in a case where eyelids of the occupant are closed in the image.

13. The server according to claim 8, wherein the processor is configured to determine that the contact power receiver is utilized to receive the power in a case where the processor detects that the occupant wears an earphone or a loudspeaker of the moving object reproduces sound based on the information.

14. The server according to claim 8, wherein the processor is configured to determine which of the contact power receiver and the non-contact power receiver is utilized to receive the power in accordance with a desired power receiving method input by an input device.

15. A non-transitory computer-readable recording medium on which an executable program is recorded, the program causing a processor of a computer to execute:
receiving information on a state of an occupant boarding a moving object from the moving object, and
determining which of a contact power receiver and a non-contact power receiver is utilized to receive power based on the received information, the a contact power receiver being connected to an external contact power feeding device and configured to receive the power from the external contact power feeding device, and the non-contact power receiver being configured to receive the power from an external non-contact power feeding device in a non-contact manner.

16. The non-transitory computer-readable recording medium according to claim 15, wherein the program causes the processor to execute determining that the non-contact power receiver is utilized to receive the power in a case where the processor detects that the occupant is requesting a quiet environment based on the received information.

17. The non-transitory computer-readable recording medium according to claim 15, wherein the program causes the processor to execute determining that the non-contact power receiver is utilized to receive the power in a case where the processor detects that the occupant is studying or sleeping based on the information.

18. The non-transitory computer-readable recording medium according to claim 17, wherein
the received information includes an image of the occupant, and
the program causes the processor to execute detecting that the occupant is studying in a case where the occupant holds a writing instrument and faces downward in the image.

19. The non-transitory computer-readable recording medium according to claim 17, wherein
the received information includes an image of the occupant, and
the program causes the processor to execute detecting that the occupant is sleeping in a case where eyelids of the occupant are closed in the image.

20. The non-transitory computer-readable recording medium according to claim 15, wherein the program causes the processor to execute determining that the contact power receiver is utilized to receive the power in a case where the occupant wears an earphone or a loudspeaker of the moving object reproduces voice based on the received information.
